(19) United States
(12) Patent Application Publication
(10) Pub. No.: US 2026/0054950 A1
(43) Pub. Date: Feb. 26, 2026

(54) Grain bag unloader attachment for core and bag removal

(71) Applicant: Adam M LLC, Pukwana, SD (US)

(72) Inventor: Adam Mayer, Pukwana, SD (US)

(21) Appl. No.: 19/302,655

(22) Filed: Aug. 18, 2025

Related U.S. Application Data
(60) Provisional application No. 63/692,839, filed on Sep. 10, 2024.
(60) Provisional application No. 63/685,215, filed on Aug. 20, 2024.

(51) Int. Cl. B65H 18/08; A01F 25/20

(52) U.S. Cl. CPC B65H 18/08; A01F 25/20; B65H 2701/191

(57) ABSTRACT

A device and method for winding/rolling up a grain bag when emptying a grain bag and also for removing a core from a coiled roll of spent grain storage bag so that the coiled roll of spent grain storage bags can be removed from a grain bag unloading assembly without uncoiling or unrolling the coiled roll of spent grain storage bags. The device uses a hydraulic system to extract the core from which the grain bag length is wound around during unloading of the grain storage bag. The core is similarly extendable to allow for rolling subsequent grain storage bags therearound.

### CROSS REFERENCE TO RELATED APPLICATIONS

This application claims priority to U.S. provisional patent application Serial No. 63/685,215, filed on August 20, 2024, and U.S. provisional patent application Serial No. 63/692,839, filed on September 10, 2024, the contents of which are incorporated herein in their entirety.

### BACKGROUND

The present invention relates to a device for mechanically removing a core from a coil of used grain storage bags.

Grain bags are large sized polyethylene tube-shaped bags used to store agricultural produce. The bags can vary in diameter from approximately 6.5 feet to approximately 13 feet and in length from approximately 100 feet to approximately 300 feet. Each bag is originally a tube or sleeve open at both ends that are single use only.

When used to collect and store grain, eventually the bags must be emptied for transporting the grain for end use processing. Devices for unloading grain bags include grain vacuums which are configured with attachments for removing the grain from the storage bag. Generally, when removing the grain from the grain storage bag, the grain bag is emptied as the bag rolls up onto a winder, while a machine vacuums the grain out and deposits it into a receptacle for transport. Once the grain bag is emptied, its length is coiled around the bag winder tube. The bag winder tube is disconnected from the winding assembly so that the bag winder tube may be freely rotated in a bag unwinding direction. This enables the bag, which was wound upon the bag winder tube, to be pulled therefrom and unwound. In some equipment, the ends of the rolling equipment must be manually opened, the winding tuber removed therefrom with the bag still wound therearound. The bag must be manually removed from the winder tube which requires cutting, unwinding or a combination of both. For example, removal of the grain bag from an unloading system requires unwinding the entire length of grain bag from the winder tube. This grain bag unwinding is not only a manual process, but also time consuming and requires removal of the entire length of grain bag from the winder tube in a manner that uncoils the bag and creates a larger mass of grain bag for removal.

### SUMMARY

An aspect of the present disclosure relates to a base grain bag rolling system that can either be adapted for use on a grain vacuum, or be provided as a self-contained system for an auger unloader. The roller mechanism may be provided as a base system, easily adaptable for various uses. The roller mechanism base system winds up a grain bag in combination with, for example, an auger system for removing the grain therein. Once the grain bag is would up, the roller mechanism is adapted to release the bag from the roller mechanism for removal and/or disposal without having to unwind or unroll the bag from the system.

Another aspect of the present disclosure relates to a base roller system for winding a grain bag up during unloading of the grain bag. The system comprises a wheeled frame; a grain bag winding tube rotatably coupled to the frame, wherein the winding tube comprises an outside winder and an inner winder which separate to drop a wound bag from the winding tube and wherein the winding tube rotates to take up and wind up a grain storage bag therearound while emptying grain therefrom wherein the wheeled frame supports the grain bag winding tube and wherein the wheeled frame comprises two sections that are moveable with respect to one another to coordinate with separating of the outside winder and inner winder to drop a wound up grain bag.

In one or more embodiments the system is configured for use as a self-contained auger unloader and is an auger attachment for removably coupling to a grain auger.

In one or more embodiments the system is operably coupled to a grain vacuum for emptying the grain bag during rolling up of the grain bag.

Another aspect of the present disclosure relates to a grain bag winder and unloader. The winder and unloader comprises a frame comprising an upper support bar, a lower support bar and at least two vertical, spaced apart and opposing side support bars connecting the upper and lower support bars; a moveable support bar positioned substantially parallel to the side support bars and moveably connected to the upper support bar and a lower support bar such that a spacing between the moving support bar and opposing side support bars is selectively adjustable; at least one hydraulic cylinder operably connecting the movable support bar to the frame for linear movement of the moving support bar in reciprocal directions with respect to the frame; and the grain bag winding tube rotatably coupled to the moveable support bar and extending from rotatable connection with the movable support bar towards the frame wherein the winding tube is linearly moved with the movable support such that the winding tube extends and retracts into a space for forming the roll of grain storage bag when emptying grain therefrom.

The frame comprises four spaced apart side supports along a length of the upper and lower support bars providing two adjacent open spaces in the frame wherein a first space is the space for forming the roll of grain storage bag when emptying grain therefrom. The second adjacent open space is a space for stabilizing the frame when unloading the grain bag.

Each of the upper and lower support bar operably support a housing of a hydraulic cylinder and wherein a piston rod of each hydraulic cylinder is operably connected to the movable support bar to linearly displace the moveable support bar in reciprocal directions.

The grain bag winding tube is rotatably coupled to the moveable support bar with a rotatable bearing connection.

The frame is a network of interconnected metal tubes. In one or more embodiments, the frame is a steel tube frame.

The frame is configured to support an inside roller and an outside roller within the space for forming the roll of grain storage bag and wherein the winder tube extends and retracts through the outside roller to allow the outside roller to move for easy removal of a coil of used grain bag from the frame.

Yet another aspect of the present disclosure relates to a method of removing a core from a coiled roll of spent grain storage bag for removal of the coil from a grain storage bag unloading assembly. The method comprises providing a framework for supporting a rotatable core thereon where in the core is linearly movable into and out of the framework; providing at least one hydraulic cylinder operably connecting the framework to a movable support which is operably coupled to the core; rotating the core to coil the grain bag therein while emptying grain from the grain storage bag; and actuating the at least one hydraulic cylinder to retract the core and extract the core from the coil of spent grain storage bag.

Retracting the core opens a space around the coil of spent grain storage bag for removal of the coil from the grain bag unloading assembly.

Securing an open end of a full grain storage bag to the core is carried out by extending the core into the framework and clamping a portion of the open end of the full grain bag between the core and an inside roller plate and rotating the core to wind the bag therearound.

Extending the core into the framework further comprises pushing an outer roller plate to a closed position with a perimeter edge of the core for securely coiling the grain storage bag around the rotating core while concurrently emptying grain from the grain storage bag.

Retracting the core from the coiled grain storage bag comprises allowing the outer roller plate to move to an open position for clearance for removal of the entire coil of grain storage bag without uncoiling the roll.

### BRIEF DESCRIPTION OF THE DRAWINGS

FIG. 1 illustrates a base system for winding and unloading a grain bag with an auger attachment according to one or more embodiments described herein.

FIG. 2 is a front view of an embodiment of a device for extending and retracting a grain bag winder tube into and from a grain bag winding assembly of a grain bag unloading system.

FIG. 3 illustrates the winder tube in a closed, or extended position for winding emptied grain bag length therearound.

FIG. 4 is a front view of an inner roller of a winding assembly according to one or more embodiments of the device described herein.

FIG. 5 is an end view of the inside roller.

FIG. 6 is a front view of the winder tube in an open, or retracted position in use with a grain bag unloading system.

FIG. 7 is a front view of another embodiment of a device for extending and retracting a grain bag winder tube into and from the grain bag winding assembly of a grain bag unloading system.

### DETAILED DESCRIPTION

A grain bag removal device described herein removes a bag winder tube from a coil of spent grain bag such that the coil of spent grain bag can be removed from the winding assembly of a grain bag unloading system without uncoiling the spent grain bag. The grain bag removal device and the grain bag unloading system described herein can be used with a grain vacuum unloader for removal of the grain from the bag but can also be used as a stand-alone or self-contained auger unloader which is easily able to be switch from one to the other. When unloading a grain bag, the bag is coiled onto the bag winder tube which ends up serving as a core to a roll of spent grain bag. The device described herein is configured to retract the bag winder tube from the grain bag coil, while the coil remains within the bounds of the winding assembly and once the tube is retracted, the coiled spent bag can released, dropped, or be cleanly removed from the winding assembly and discarded or recycled. The device described herein removes the core from the coil, leaving the coil intact for removal and eliminates the need for unwinding of the coiled bag for removal after emptying.

With the device described herein, the winder tube is extendable into a position in the winding assembly for securing to an end of a full grain bag and the winder tube is rotatable for take up and coiling of the grain bag therearound as the grain bag is emptied. Once coiled, the bag winder tube is then retractable from the coil and retracted from the winding assembly to leave the coiled spent grain bag within the winding assembly for easy removal therefrom and subsequent disposal.

The grain bag removal device described herein can be a base system. That is, the base can be incorporated into a grain bag unloading system, for example, a grain bag unloading system for large sized grain bags having a winder or roller that gathers the used plastic from the grain bag as the bag is gradually emptied. The unloading system may be configured for use with machinery for removal of the grain from the bag, such devices include but are not limited to a grain vacuum. In such an unloading system, the grain is unloaded via a grain vac, suction blower, pneumatic conveyor, or other machinery that is configured to expel the grain the from the bag to an awaiting chamber, truck, cart, or mobile container and concurrently the bag is wound around the winder tube. Once the grain bag is unloaded and the bag length is wound around winder tube, the device according to one or more embodiments herein is hydraulically activated to retract the winder tube from the coiled bag and thus remove the winder tube from the spent grain bag and otherwise free the coiled grain bag from the unloading system for removal of the coiled grain bag. This allows an operator to simply remove the coiled plastic from the unloaded system, rather than uncoil the spent grain bag length form the winder tube, as the grain bag length may be in the range of 100 to 300 feet.

In another embodiment, the base system is self-contained and can be attached to an auger unloader. The base system can be easily adapted for both uses and/or additional uses.

In one embodiment, an auger attachment is easily removed or added to the system for use therewith. The base roller may be operably connected to and comprise hydraulic cylinders which are attached to pull the roller from the core of the coiled bag to drop the bag once the bag has been tightly rolled up, for example as a tight rolled up bale. The base roller may also comprise two sections meeting in the middle of a bag when coiling. In such an embodiment there are two rollers, such as a left or outside and right or inside roller in the system (orientation may change depending on view and/or installation). One or both rollers can be moved laterally to release the coiled bag from the assembly.

One outside roller side, when rolling a bag, may be held more towards a center of the bag roll, for example, roughly 3 inches more toward center so that when the bag is dropped from the roller it is released as this allows for the release of all side friction on the bag, encouraging easy removal.

The inside roller side may be considered a drive side of the roller. The inside roller is connected to a gearbox that is turned hydraulicly to roll the bag attached to the rollers and the speed of which controls the grain unload rate. The outside roller is a follower roller. The outside roller may also be movable horizontally so that the roller is withdrawn from the core of the coiled bag from one or both sides to drop the coiled bag.

Moreover, the base system may be a wheeled assembly allowing for easy transport and installation or use. The wheels of the base assembly may be hydraulic brake-controlled wheels. The pressure on the brakes controls the tightness of the bag as it is rolled and to keeps the machine from running over the top of bag if on a incline.

In further detail, in one embodiment, as illustrated in the figures, a grain bag removal device 10 automatically retracts and extends a winder tube 12 for a grain bag unloading system 100 such that the winder tube 12 is automatically withdrawn from a coil 14 of spent grain bag 16, freeing the coil 14 of spent bag from the unloading system 100 for removal and disposal. While the device 10 illustrated herein utilizes hydraulics to retract and extend the winder tube 12, alternative mechanisms for linear movement of the winder tube 12 are contemplated and within the scope of this disclosure.

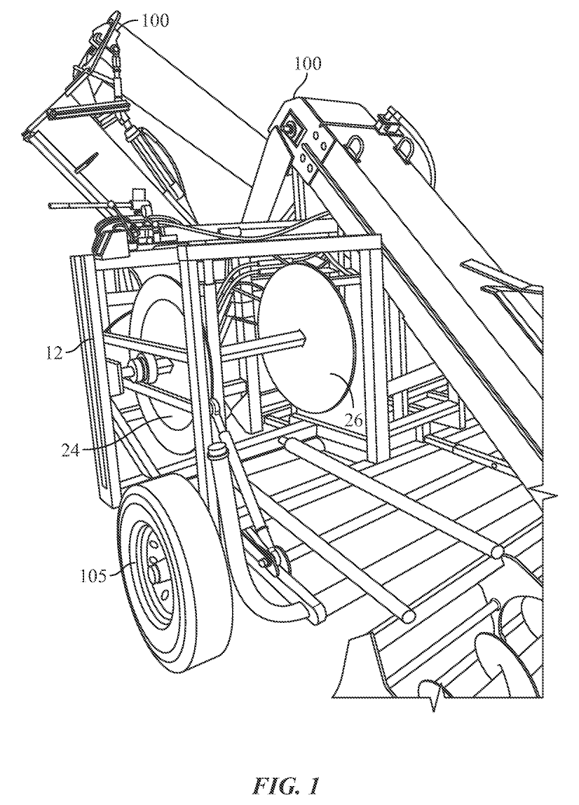

Referring first to FIG. 1, which illustrates an embodiment of the base system 10 as used with an auger 100. The base system 10 comprises a base roller 12 also referred to herein as a winder tube 12, which is operably coupled to one or more hydraulic cylinders 20 which push and/pr pull the base roller 12 such that the base roller 12 can be pulled from inside a core of a bag rolled thereon to release and/or drop the rolled grain bag off of the base system.

In one or more embodiments, and as illustrated in FIG. 1, the base roller 12 may comprise two rollers 12a, 12b where the rollers are linearly aligned and meet in a center of the width of the core of the bag such that the bag is wound around both rollers and retracting one or both rollers in opposing directions drops the bag would therearound. That is, the base roll12 can be removed from the core on one or both sides in one or more embodiments.

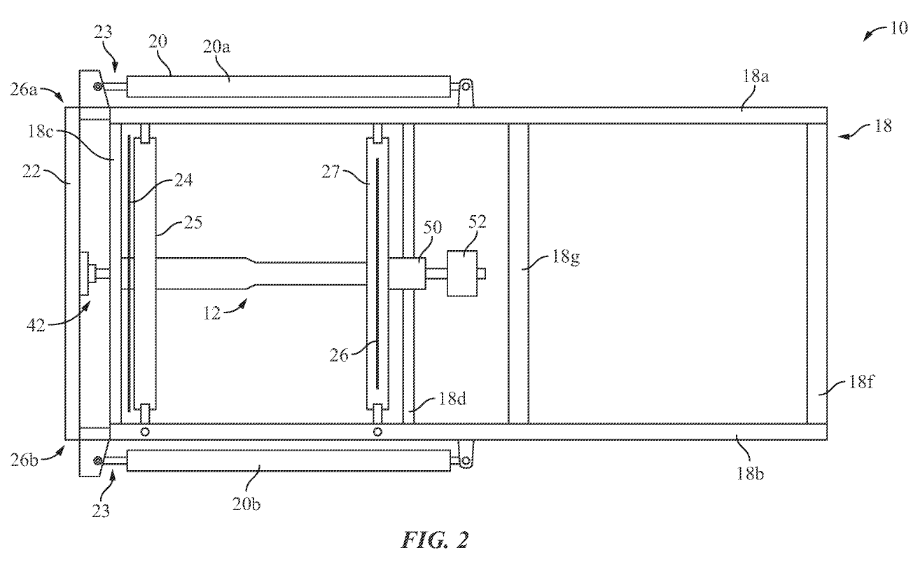

As shown in FIG. 2, an outside roller 24 comprises a side plate for controlling the grain bag position when rolling or winding the same onto the base roller 12 and is connected to base roller 12a. An inside roller 26 comprises a side plate controlling the grain bag position when rolling or winding the same onto the base roller 12 and is connected to base roller 12b. In one embodiment, one of outside roller 24 or insider roller 26 may be a drive roller and the other a follower. As illustrated, the inside roller 26 is a drive roller and is operably connected to gear box and power source for rolling the base roller 12 and thus winding the grain bag therearound while unloading the grain bag. In the embodiment illustrated, the drive roller 12 is also hydraulically powered.

The base system 10 also comprises a frame 18 and a wheel system 105 for supporting the frame in a mobile, adjustable and/or upright manner spaced from the ground allowing clearing for the base roller 12 and the grain bag. The wheels 105 may be hydraulic brake controlled wheels. The pressure on the brakes then controls the tightness of the bag as it is rolled/wound up on the base roller 12 and prevents the device from running over the top of the bag if the system is positioned on an incline for example.

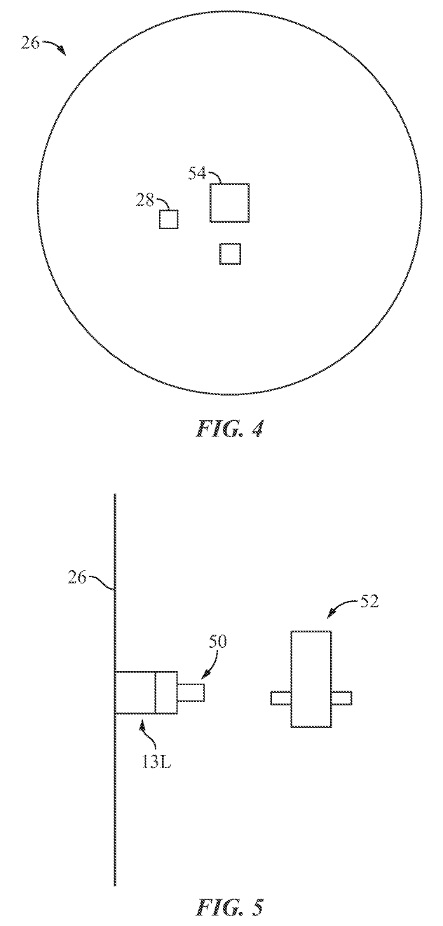

In further detail as illustrated in FIGS. 1-6, the grain bag removal device 10 supports one or more hydraulic cylinders 20 for retraction and extension of the winder tube 12. The device comprises a frame 18 which includes an upper frame support 18a and lower frame support 18b connected by opposing side supports 18c and 18d. The frame 18 may be comprised of a tubular frame work comprising metal extrusions of steel, aluminum or a like material. Individual components of the frame 18 may be fixedly secured by way of weldments, brackets, bearings, rotatable bearings, fasteners, and combinations thereof. The extrusions may be metal tubes of any cross-sectional dimension including but not limited to square tubes or round tubes. The frame 18 may be provided in varying overall dimensions sufficient to support a coiled spent grain bag therein, the grain bag length ranging from about 100 to about 300 feet or more. In the embodiment illustrated in the figures, the frame 18 is comprised of interconnected 3 inch and 3.5 square steel tubing, however alternative dimensions, materials, and configurations may be used to achieve the same function as described herein.

As illustrated in FIGS. 1-3, the frame 18 supports at least one linear actuator for retraction and extension of the winder tube 12. For example, the frame supports at least one hydraulic cylinder 20. In the embodiment illustrated two hydraulic cylinders 20a, 20b are provided and are operably supported on the frame 18. For example, an upper hydraulic cylinder 20a is fixedly secured to the upper support 18a and a lower hydraulic cylinder 20b is operably secured to the lower support 18b. Distal ends of piston rods 23 of each hydraulic cylinder are operably coupled a vertical support bar 22 that is movable with respect to the frame 18. The hydraulic cylinders 20a, 20b are actuated in concert to retract and extend the support bar 22 with respect to the frame 18. Power and/or control mechanisms for the hydraulic cylinders may be mounted on or supported by the frame 18.

The piston rod 23 of each hydraulic cylinder 20a, 20b is coupled to a lower end 26b and upper end 26a, respectively, of the support bar 22. The piston rods 23 may be coupled to the support bar 22 by a bracket, weldment, fastener, or combination thereof. In the embodiment illustrated, the hydraulic cylinders 20 may be approximately four feet in length or a length sufficient such that the piston rods 23 actuate to retract the support bar 22 and thus winder tube 12 a distance of at least about 2.5 feet and/or to allow sufficient clearance of the winder tube 12 so that the coiled roll of spent grain bag 16 can be easily removed from the unloader.

In the embodiment illustrated, the support bar 22 is slidably connected to the frame 18. The support bar may in one or more embodiments include two parallel but spaced apart support bars 22 and 22’, collectively referred to herein as support bar 22, wherein the support bars 22 and 22’ are spaced apart by way of connection to slidable arms 31 and 33 which are slidable within ends of the upper and lower support bars 18a and18b of the frame 18. For example, as illustrated in further detail in FIG. 5, support bars 22 and 22’ are secured at the upper 26a and lower 26b ends to the upper slidable arm 31 and lower slidable arm 33. Connection mechanisms 30, 32 such as tubing, brackets, or combinations thereof, are further provided for securing each of the upper slidable arm 31 and lower slidable arm 33 to ends of the piston rods 23 to sliding movement of the arms 31 and 33 within the upper and lower support bars 18a and 18b of the frame 18. As such, the arms 31 and 33 are slidably or moveably coupled to the frame 18 at upper frame support 18a and lower frame support 18b, for example in a manner where a cross-sectional dimension of each of the upper end support arm 31 and lower end support arm 33 is sufficient to allow the arms 31 and 33 to be receiving into the tubular structure of support bars 18a and 18b respectively and to slide within an interior space of the upper frame support 18a and lower support 18b with actuation of the hydraulic cylinders 20.

The support bar 22 is further coupled to a first end 11 of the winder tube 12 such that the winder tube 12 retracts from and extends into a bag coil support space 34 substantially within the frame 18 as the hydraulic cylinders 20a, 20b are actuated. For example, the support bar 22 is coupled at one more locations on a length of the support bar 22 to the first end 11 of the winder tube 12. The second, opposing end 13 of the winder tube 12 extends into the bag coil support space 34 and removably connects to the roller and coupler 28.

As illustrated in FIG. 1,2 and 4, the support bar 22 is operably couplable to the winder tube 12 at a location along the length of the support bar 22 which may be approximately on the center of the support bar 22. A coupling 42 allows for fixed connection with the winder tube 12 such that the winder tube 12 moves linearly along with the linear movement of the support bar 22 for extension and retraction. In one or more embodiments, the coupling 42 also allows for rotational movement of the winder tube 12 for take up of the grain bag 16 during emptying operations.

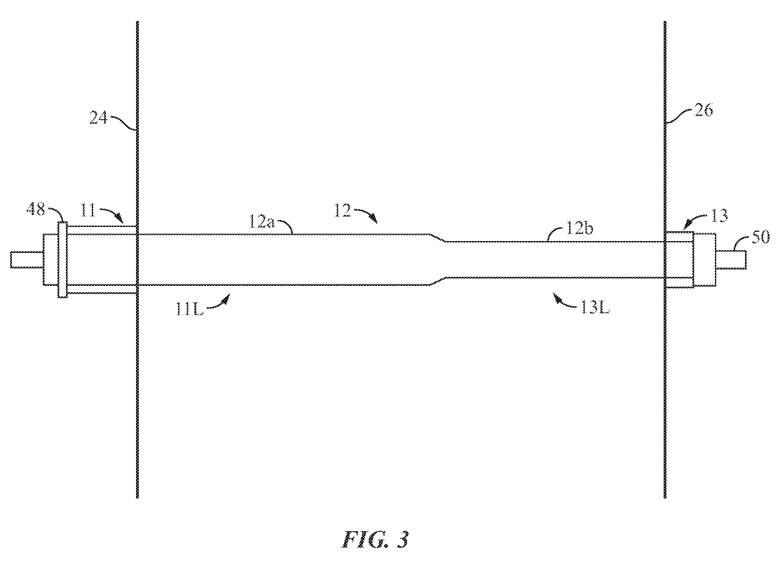

In one or more embodiments, the coupling includes a bearing such as a rotary bearing and cover therefor for rotatably and fixedly coupling the first end of the winder or roller tube 12 to the support bar 22. In further detail, as shown in FIG. 3, in one or more embodiments the roller tube 12 has a length of approximately four feet with a first end length 11L having a greater diameter than a second end length 13L and an angled neck 15 connecting the two lengths 11L and 13L. When connecting the roller tube 12 to grain bag winding components within the grain bag support space surrounding the roller tube, the winder or roller tube 12 is slidably inserted into a reinforcement connector which guides the winder tube 12 for extension and retraction into and out of the grain bag support space between the inside and outside rollers 24, 26 . For example, in one embodiment the reinforcement connector is a tube having a length and a diameter such that the inner diameter of the tube allows the winder tube 12 to slidably move within the tube. The reinforcement connector may be supported on a cross support 18s which is positioned on a sidewall 18b of the frame 18. This reinforcement connector further aids in maintaining the winder tube 12 centered when extending, retracting, and/or rotating of the winder tube 12. The first end 11 of the winder tube 12 may also be provided with a collar or stepper 48 which provides an extended perimeter to the first end length 11L of the winder tube 12. This stepper 48 may be provided to push against an outside roller end 24 of the winding component to move the outside roller 24 to a “closed position” for winding of the bag onto the bag winder tube 12. FIG. 2 illustrates the roller end 24 in a closed position. When the winder tube 12 is retracted, the stepper 48 is retracted and the outside roller end 24 opens to free the coiled spent grain bag from the bag support space 34 as illustrated in FIG. 5.

The roller tube 12 is extendable into and through the assembly to operably connect to an end shaft 50 of the winder tube 12 to a gear box 52 which provides rotational movement to the shaft 50 for rotating the winder tube 12 when connected thereto. These components may be supported on the frame 18 by a second side support 18d of the frame 18. In one or more embodiments, the frame 18 may comprise additional vertical side supports 18e, 18f extending between and connecting the upper frame support 18a and lower frame support 18b. A space is provided by the spacing between side supports 18e, 18f of the frame 18 and allows the frame 18 to be supported and/or coupled to a grain vac or other equipment for the unloading of grain bags concurrently while winding the bag around the winder tube 12.

The inner and outer roller ends 24, 26 may also serve as a removable guide allowing for bag removal as well as guides for the grain bag being wound up on the roller 12 during unloading. For example, the ends 24, 26 are positioned on opposing sides of the bag coil support space around the roller 12. The outside roller 24 and inside roller 26 are each further provided with an aperture to allow the retraction and extension of the roller tube 12 there through and support the rotational movement of the roller tube 12. A removable guide 27 may be provided and used with the inside roller 26 and/or outside roller end 24.

Referring back to FIG. 3, the insider roller 26 is a plate 26 provided with a tube aperture configured to receive an end shaft length of the second end 11 of the winder tube 12 therethrough. In the embodiment illustrated, the inside roller 26 is a circulate plate having a diameter of about 27 inches and having a thickness of about ¼ inch. The outside roller may have similar dimensions. Also provided on an inner face of the inside roller 26 are one or more apertures which provide starter holes for catching an end of the roll of grain bags 16, generally the open end of full bag of grain, and allows the bag to catch, couple and easily wind around the winder 12 as the winder tube 12 is rotated and the grain bag 16 emptied. As the hydraulic cylinders 20a, 20b are actuated to extend the winder bar 12 in a position for unloading the grain bag and winding the grain bag therearound, the winder bar 12 can be used to catch and pin an end of the grain bag between the winder tube 12 and the inside roller 26 for winding the bag easily therearound. The inside roller 26 also receives the second end 13 of the winder tube 12 when extending the winder tube 12 into the frame 18 for winding spent grain bag 16 therearound. Approximately centered in the inside roller is a tubular aperture 54 having inner dimensions for its opening which allow the second end length 13L of the winder tube 12 to slide therein. For example, the tubular aperture is a 3.5 inch square opening wherein the second end length 13L is a 3 inch square tubular shaft end.

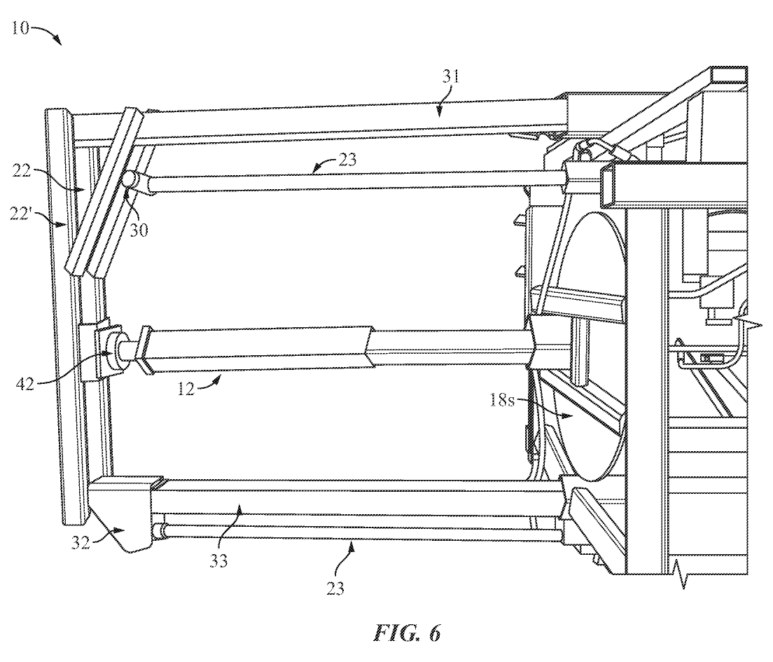

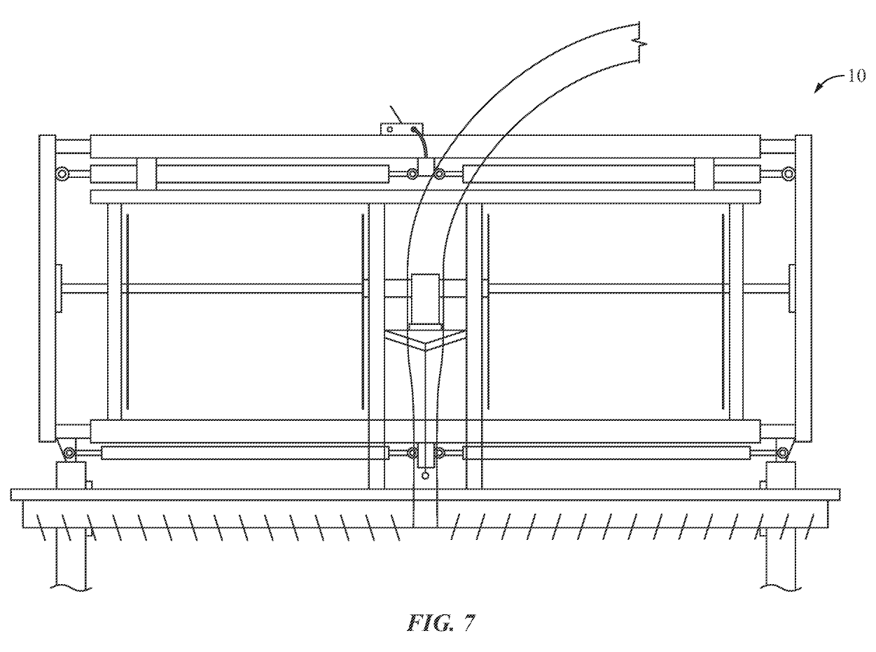

Another embodiment of the grain bag removal device 10 illustrated in FIG. 6. This device 10 includes a hydraulic system for extension and retraction of a roller core pipe or tube for removal from a spend and wound grain bag and which may be positioned on an auger.

Although the present disclosure has been described with reference to preferred embodiments, workers skilled in the art will recognize that changes may be made in form and detail without departing from the spirit and scope of the disclosure.

1. A base roller system for winding a grain bag up during unloading of the grain bag, the system comprising:
a wheeled frame;
a grain bag winding tube rotatably coupled to the frame, wherein the winding tube comprises an outside winder and an inner winder which are separable to drop a wound bag from the winding tube and wherein the winding tube rotates to take up and wind up a grain storage bag therearound while emptying grain therefrom,
wherein the wheeled frame supports the grain bag winding tube and wherein the
wheeled frame comprises two sections that are moveable with respect to one another to coordinate with separating of the outside winder and inner winder to release a wound up grain bag from the winding tube of the system.

2. The system of claim 1 wherein the system is configured for use as a self-contained auger unloader and is an auger attachment for removably coupling to a grain auger.

3. The system of claim 1 wherein the system is operably coupled to a grain vacuum for emptying the grain bag during rolling up of the grain bag.

4. A grain bag winder and unloader, the winder and unloader comprising:
a frame comprising an upper support bar, a lower support bar and at least two vertical, spaced apart and opposing side support bars connecting the upper and lower support bars;
a moveable support bar positioned substantially parallel to the side support bars and
moveably connected to the upper support bar and a lower support bar such that a spacing between the moving support bar and opposing side support bars is selectively adjustable;
at least one hydraulic cylinder operably connecting the movable support bar to the frame for linear movement of the moving support bar in reciprocal directions with respect to the frame; and
the grain bag winding tube rotatably coupled to the moveable support bar and extending
from rotatable connection with the movable support bar towards the frame wherein the winding tube is linearly moved with the movable support such that the winding tube extends and retracts with respect to a space which holds and forms the roll of grain storage bag therein when emptying grain therefrom.

5. The winder and unloader of claim 4 wherein the frame comprises four spaced apart side supports along a length of the upper and lower support bars providing two adjacent open spaces in the frame wherein a first space is the space for forming the roll of grain storage bag when emptying grain therefrom.

6. The winder and unloader of claim 5 wherein the second adjacent open space is a space for stabilizing the frame when unloading the grain bag.

7. The winder and unloader of claim 4 wherein each of the upper and lower support bar operably support a housing of a hydraulic cylinder and wherein a piston rod of each hydraulic cylinder is operably connected to the movable support bar to linearly displace the moveable support bar in reciprocal directions.

8. The device of claim 4 wherein the grain bag winding tube is rotatably coupled to the moveable support bar with a rotatable bearing connection.

9. The device of claim 4 wherein the frame is a network of interconnected metal tubes.

10. The device of claim 4 wherein the frame is a steel tube frame.

11. The device of claim 4 wherein the frame is configured to support an inside roller and an outside roller within the space for forming the roll of grain storage bag and wherein the winder tube extends and retracts through the outside roller to allow the outside roller to move for easy removal of a coil of used grain bag from the frame.

12. A method of removing a core from a coiled roll of spent grain storage bag for removal of the coiled roller from a grain storage bag unloading assembly, the method comprising:
providing a framework for supporting a rotatable core thereon where in the core is linearly movable into and out of the framework;
providing at least one hydraulic cylinder operably connecting the framework to a movable support which is operably coupled to the core;
rotating the core to coil the grain bag therein while emptying grain from the grain storage bag; and
actuating the at least one hydraulic cylinder to retract the core and extract the core from the coil of spent grain storage bag to release the coil of spent grain bag from the framework.

13. The method of claim 12 wherein retracting the core opens a space around the coil of spent grain storage bag for removal of the coil from the grain bag unloading assembly.

14. The method of claim 12 and further comprising securing an open end of a full grain storage bag to the core by extending the core into the framework and clamping a portion of the open end of the full grain bag between the core and an inside roller plate and rotating the core to wind the bag therearound.

15. The method of claim 14 wherein extending the core into the framework further comprises pushing an outer roller plate to a closed position with a perimeter edge of the core for securely coiling the grain storage bag around the rotating core while concurrently emptying grain from the grain storage bag.

16. The method of claim 15 wherein retracting the core from the coiled grain storage bag comprises allowing the outer roller plate to move to an open position for clearance for removal of the entire coil of grain storage bag without uncoiling the roll.
